(19) United States
(12) Patent Application Publication
(10) Pub. No.: US 2005/0162445 A1
(43) Pub. Date: Jul. 28, 2005

(54) Method and system for interactive cropping of a graphical object within a containing region

(75) Inventors: Michael Chilton Sheasby, Boucherville (CA); A. Michael Mondry, Nun's Island (CA)

Correspondence Address: Michael Sheasby, 195 Louis-Lalande, Boucherville, QC, CA

(73) Assignee: LumaPix, Boucherville (CA)

(21) Appl. No.: 10/761,315

(22) Filed: Jan. 22, 2004

(51) Int. Cl. G09G 5/00

(52) U.S. Cl. 345/620

(57) ABSTRACT

A method and computer graphics program executed by a processor is described for producing an optimal view of a graphical object within a containing framed region. The program includes instructions for interactively specifying the subset of a graphical object visible within a containing region; to specify the region, the user manipulates visual control objects, or handles, representing the extent of the source image visible within the containing region. The handles determine the position of the corners of the source image that are mapped to the containing region; the result of the manipulation is an apparent expansion or decimation of the contained image within the unchanging on-screen frame.

### CROSS-REFERENCE TO RELATED APPLICATIONS

The present invention shares the same inventors and assignee as, and is related to, the following applications:

Docket number pp-01-01-2003, entitled “METHOD AND SYSTEM FOR DISTRIBUTING MULTIPLE DRAGGED OBJECTS”, as well as Docket number pp-03-01-2003, entitled “METHOD AND SYSTEM FOR INTERACTIVE REGION SEGMENTATION”, in that the methods of object distribution and region segmentation described therein may optionally be combined with the user interface elements described herein.

The present application formalizes the provision utility patent application with application Ser. No. 60-446,757 and confirmation number 4658, filed on Feb. 3, 2003.

### FIELD OF THE INVENTION

The present invention relates particularly to a graphics imaging system for producing visual designs and more particularly to a graphics imaging system that presents a display of one or more regions each containing a graphical object, for example a bitmapped image.

### BACKGROUND OF THE INVENTION

Computer systems are commonly used to process digital imagery, such as that captured by digital cameras and scanners, into new forms. The processing may include selecting and positioning a subset of an image within a surrounding region or frame. This process is sometimes called “cropping” in existing art.

A simplistic approach to cropping can be compared to cutting the edges off a photograph with a pair of scissors: as the user cuts more material away, the size of the photograph is reduced. In our abstracted implementation, the overall dimensions of the region holding the displayed image remain constant, while the visible subset of the image being cropped appears to grow or shrink within the confines of that fixed region. The user interactively indicates a region of interest, and that region is stretched to fit the fixed bounding region.

In prior art, maintaining the exterior dimensions of a bounding region while cropping the interior can be a cumbersome task. For example, in common graphics editing applications such as Adobe® PhotoShop or JASC® Paint Shop Pro, cropping an image results in a smaller overall image, as with a pair of scissors; the user must resize the cropped result back to the original size manually.

Microsoft® Word provides an example of a cumbersome mechanism for cropping against a fixed containing region: the user creates a frame within a document, enters a second, new document representing the contents of that frame, positions graphics and text within the second document, and then manipulates controls on the ‘ruler’ inside that second document that indicate the extent of the second document that will be visible within the frame in the first, or referring, document. Unfortunately, the user cannot see the cropped view of the second document in the context of the first while editing the cropping; in particular, the user cannot directly manipulate the cropping of the second document while editing the first document.

The current patent provides an elegant mechanism for the graceful manipulation of the cropping of the second document while editing the first document. This technique is particularly useful when editing visual data, such as photographs which have ‘areas of interest’ that the user cares to distinguish; however it is generally applicable to the process of cropping an extent of any two- or three-dimensional data.

### SUMMARY OF THE INVENTION

The present invention provides for an interaction technique, implementable on a computer readable medium, for interactively specifying a subset of a graphical object for display within a containing region. We use the term ‘region’ to indicate a bounded area on a computer display which can be used to contain a two-dimensional entity, including by way of example a bitmapped raster image. We use the term “cropping”, or “crop-to-fill mode”, to mean the selection of said subset of said contained image; the user perceives the net result of changing the region defined on the contained image as a cropping of said image within the extent of said containing region.

In one aspect of the invention, the user enters crop-to-fill mode, interactively selects a particular subset of an image contained within a fixed bounding region, and then leaves the crop-to-fill mode.

In another aspect of the invention, the cropping is performed by direct manipulation of a control drawn on the border of said initial region with a user interface device such as a mouse or keyboard.

In another aspect of the invention, the cropping is computed using the updated position of a pointing device such as a mouse relative to the position at the start of interaction. A keyboard may also be used. The cropping enables the user to interactively select a two-dimensional subset of a contained image which will completely fill a containing region, said containing region remaining of fixed width and height throughout the operation.

### BRIEF DESCRIPTION OF THE DRAWINGS

Preferred embodiments of the invention are illustrated in the FIGURES, by way of example, with like numerals being used to refer to like and corresponding parts of the various drawings.

FIG. 1 is a drawing of a computer system suitable for implementing a system for segmenting regions, according to the present invention.

FIG. 2 depicts the relationship between regions and bitmapped source images they may contain

FIG. 3 depicts an example set of manipulators that decorate the frame of a region in the preferred embodiment of the invention.

FIG. 4 depicts region rotation using a manipulator handle.

FIG. 5 depicts region resizing using a manipulator handle.

FIG. 6 depicts region deletion using a manipulator handle.

FIG. 7 depicts image panning using a manipulator handle.

FIG. 8 depicts image cropping using a manipulator handle.

### DETAILED DESCRIPTION

In the following discussion, the present invention is described for illustrative purposes with reference to the editing of raster image information. However, one of ordinary skill in the art will recognize that the invention, in its broadest aspect, is applicable to applications other than image applications, and it is not intended that the scope of the invention be so limited. For example, the present invention is also applicable to the editing of video data, and to two-dimensional data in general. Three-dimensional data can likewise be cropped by manipulating the source extent of a three-dimensional cube of data from within a bounding volume.

Computer Imaging System

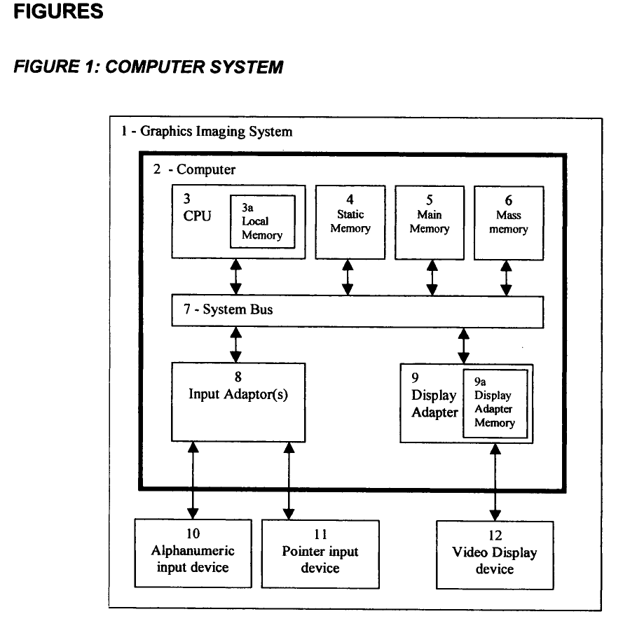

A computer graphics imaging system 1 is schematically depicted in FIG. 1. The graphics imaging system 1 includes a computer 2 that has a central processing unit (CPU) 3 which may include local memory 3a, static memory 4 such as Read-only memory (ROM), main memory 5 such as Random Access memory (RAM), mass memory 6 such as a computer disk drive, a system bus 7, adaptor(s) for external input devices 8, and a display adapter 9 which may include local memory 9a. The computer 2 may communicate with an alphanumeric input device 10 such as a keyboard, and/or a pointer device 11 such as a mouse for manipulating a cursor and making selections of data via said input adapter 8. The computer 2 communicates with a video display 12 such as a computer monitor via said display adapter 9.

The computer 2 executes imaging software described below to allow the system 1 to render high quality graphics images on the monitor 12. The CPU 3 comprises a suitable processing device such as a microprocessor, for example, and may comprise a plurality of suitable processing devices. The graphics adaptor 9 may also be capable of executing instructions. Instructions are stored in one or more of the CPU local memory 3a, static memory 4, main memory 5, mass memory 6, and/or display adapter local memory 9a and are executed by the CPU 3 or the display adapter 9.

The static memory 4 may comprise read only memory (ROM) or any other suitable memory device. The local memory may store, for example, a boot program for execution by CPU 3 to initialize the graphics imaging system 1. The main memory 5 may comprise random access memory (RAM) or any other suitable memory device. The mass memory 6 may include a hard disk device, a floppy disk, an optical disk, a flash memory device, a CDROM, a file server device or any other suitable memory device. For this detailed description, the term memory comprises a single memory device and any combination of suitable devices for the storage of data and instructions.

The system bus 7 provides for the transfer of digital information between the hardware devices of the graphics imaging system 1. The CPU 3 also receives data over the system bus 7 that is input by a user through alphanumeric input device 10 and/or the pointer device 11 via an input adaptor 8. The alphanumeric input device 10 may comprise a keyboard, for example, that comprises alphanumeric keys. The alphanumeric input device 10 may comprise other suitable keys such as function keys for example. The pointer device 11 may comprise a mouse, track-ball, tablet and/or joystick, for example, for controlling the movement of a cursor displayed on the computer display 12.

The graphics imaging system 1 of FIG. 1 also includes display adapter hardware 9 that may be implemented as a circuit that interfaces with system bus 7 for facilitating rendering of images on the computer display 12. The display adapter hardware 9 may, for example, be implemented with a special graphics processor printed circuit board including dedicated random access memory 9a that helps speed the rendering of high resolution, color images on a viewing screen of the display 12.

The display 12 may comprise a cathode ray tube (CRT) or a liquid crystal display particularly suited for displaying graphics on its viewing screen. The invention can be implemented using high-speed graphics workstations as well as personal computers having one or more high-speed processors.

The graphics imaging system 1 utilizes specialized graphics software implementing the method described in the present invention. The software implements a user interface and related processing algorithms as described in subsequent sections to enable the user to produce graphical works viewed on the display 12 and which may be stored in mass memory 6, for example the assembly of graphical objects such as bitmaps. Source material for use with such a system can include previously digitized materials stored on a computer memory 6 such as images acquired from digital cameras, scanning devices, or the internet, which may be stored on a large capacity hard or fixed disk storage device.

Regions

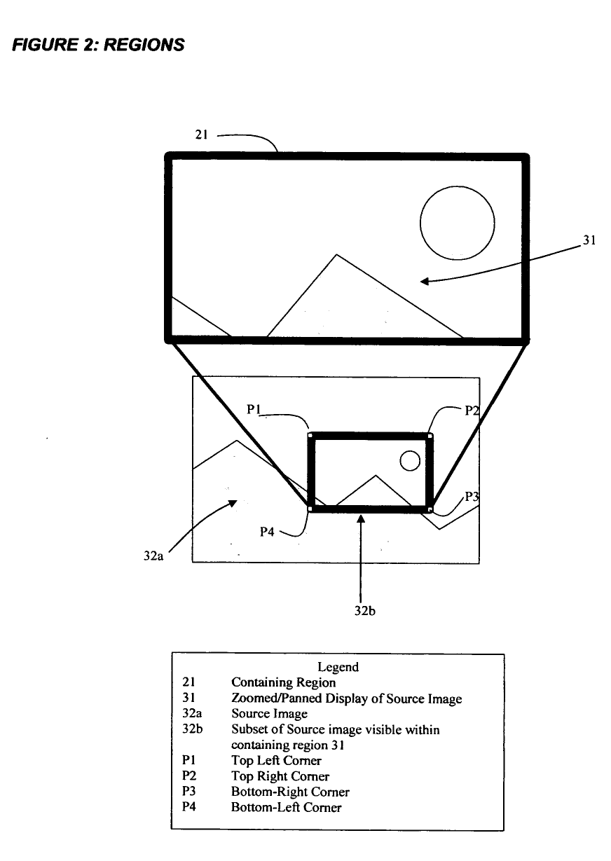

In the preferred embodiment of this invention, a graphical composition incorporates one or more graphical objects within bounding regions. As shown in FIG. 2, each of said regions 21 frames and contains at least one graphical object 31, such as a bitmapped image, which can be panned and zoomed within the frame. The graphical object 31 is a reference to at least one source object 32a, such as a bitmap.

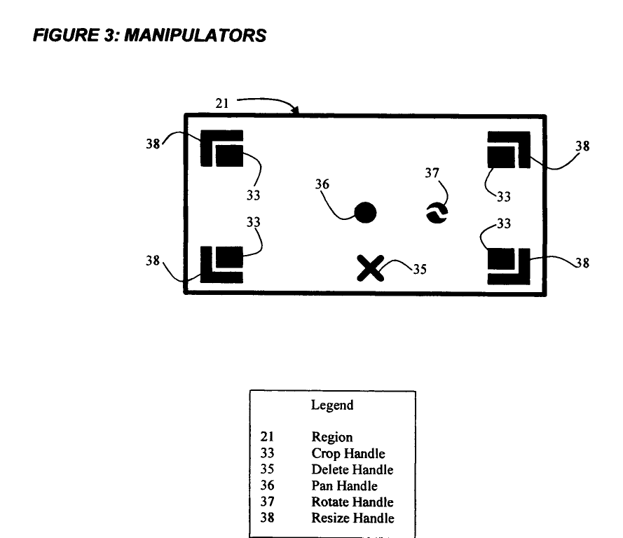

As shown in FIG. 3, the user may apply several types of manipulation to a frame by manipulating controls (33-38) which in the preferred embodiment of the invention are built into the frame of each region. These controls may be driven via a user interface device such as a mouse, or using a keyboard. The operations include:

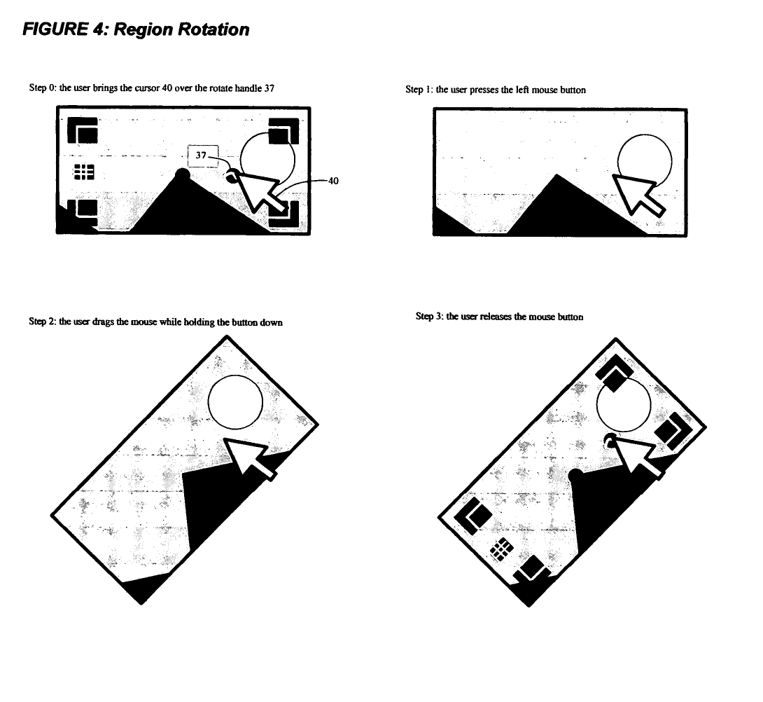

Rotating the region 21 (see FIG. 4)

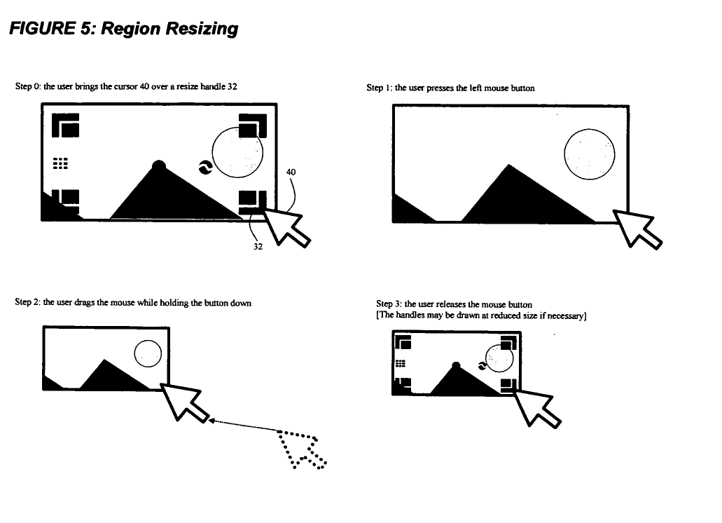

Resizing the region 21 (see FIG. 5)

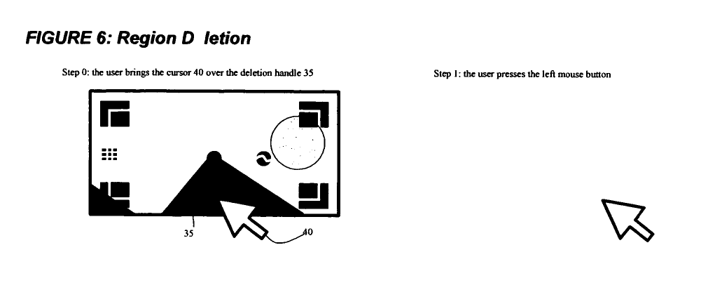

Deleting the region 21 (see FIG. 6)

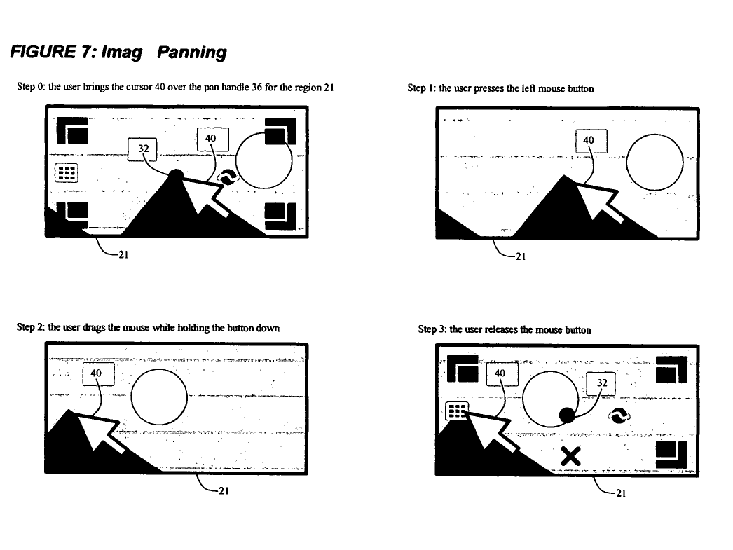

Panning the image 31 contained within the region 21 (see FIG. 7)

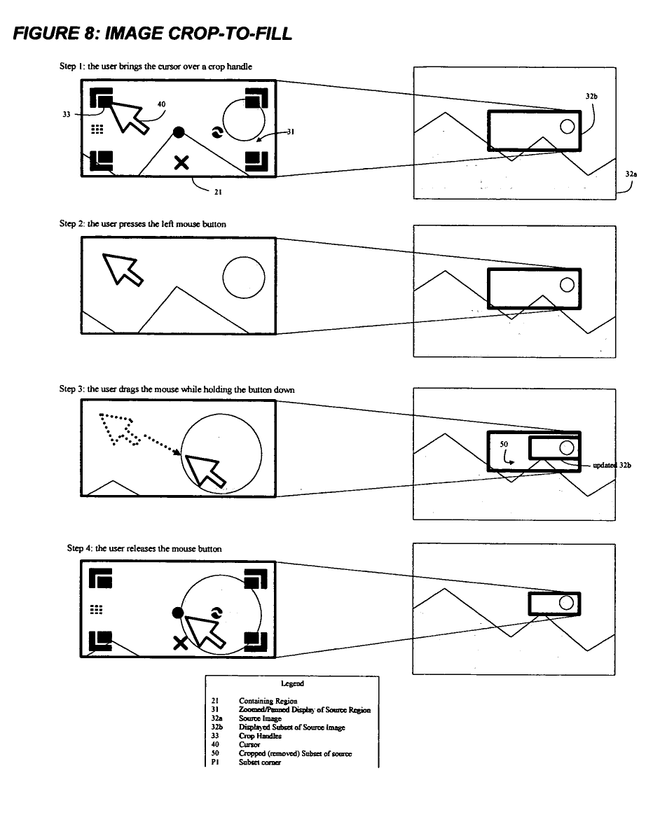

Cropping the image 31 contained within the region 21 (see FIG. 8)

Image Cropping-To-Fill

The present invention specifically relates to the selection of a subset of a contained region within a bounding frame.

Interactively resizing a bounding frame using controls built into the frame of said frame is a common operation well-known to those of ordinary skill in the art. However the interactive selection of a subset of a contained graphical object such as a bitmap without deforming the frame defining the containing region is to our knowledge unique to this invention.

Referring to FIG. 8, there is shown, in graphical form, a region 21. In one embodiment of this invention, said region 21 is decorated with interactive manipulator handles (33-38 in FIG. 3) enabling the user to apply various operations on the region 21 and the image it contains 31 via a pointing user interface device 11 (not shown). In particular there exists a set of handles 33 enabling the modification of the subset of the contained image 31 visible within said frame 21.

Said handle may appear anywhere in or about said region 21; in the preferred embodiment of the invention they appear near each of the four corners of the region 21.

Alternative Handle Layouts

With reference to FIG. 2, The aspect ratio of the containing frame 21 determines the aspect ratio of the visible subset 32b of the source image 32a visible within the containing frame 21 according to this formula:
RegionWidth/RegionHeight=SubsetWidth/SubsetHeight

Therefore the minimum information required to determine said subset 32b is the location of a corner (one of P1, P2, P3, P4) and either a width or height of said desired subset 32b. For example, once the height of the subset 32b is specified, say by P1 and P4, then the width must be equal to
(RegionWidth * SubsetHeight)/RegionHeight

For this reason it is sufficient to display only two handles to provide the user with the ability to choose any arbitrary subset of said contained image 32a.

In the preferred embodiment of this invention all four handles are displayed to enable the user to adjust each corner independently, which in our experience aids in framing objects of interest.

Crop-To-Fill Using a Mouse Input Device

In one embodiment of this invention, the user crops the contained graphical object by manipulating an input device such as a mouse. It may be helpful to think of the interaction in the following terms, as illustrated in FIG. 2:

The source image 32a is cropped by the frame defining the surrounding region 21.

The aspect ratio of the surrounding frame 21 is fixed.

The subset of the source image 32a which appears in the surrounding frame 21 can be selected by a region 32b that must have an aspect ratio matching that of the surrounding frame 21 but which can otherwise grow or shrink or translate on the source image 32a without restriction

The projection 32b of the surrounding frame 21 on the source image thus produces four points P1-P4 on the source image 32a defining the subset of the image that fills the surrounding frame 21.

Moving the crop handles 33 can therefore be thought of as a function that indirectly relocates these four points P1-P4.

The actual movement of the handles may involve additional constraints, described below.

In the preferred embodiment of the invention, as illustrated in FIG. 8, the user performs the following steps to crop a contained image:

1. Moving the mouse such that the pointer 40 is positioned over a crop handle 33

Without loss of generality and for illustrative purposes only, suppose that the user has selected the Top-Left handle, as shown in FIG. 8.

The handle 33 may assume a new visual state, such as a brightened or highlighted representation, to indicate that it will become active if the user presses the mouse button.

2. Pressing the mouse button

The handle 33 and other decoration on the frame 21 may disappear to allow the user to concentrate on the image itself.

3. Dragging the mouse in a chosen direction

The user selects a direction based on the situation.
To hide a portion of the source image 32a which is currently visible within the surrounding region 21, the user drags the mouse toward the center of said region (in this example, down and to the right). This has the effect of moving the point P1 represented by said crop handle 33 down and to the right on said source image 32a, resulting in the hiding of a region 50 of said contained image 32a and thus in containing frame 21. Note that to the user this will apparently “magnify” the visible region of the image 31.
[not illustrated] To reveal a portion of the source image 32a which is currently cropped by the surrounding region 21, the user drags the mouse away from the center of said region (in this example, up and to the left). This has the effect of moving the point P1 represented by said crop handle 33 up and to the left on said source image 32a, resulting in the revelation of a previously covered region of said contained image 32a and thus in containing frame 21. Note that to the user this will apparently “shrink” the visible region of the image 31.

As the user drags, the display of the region 21 updates to reflect the subset of the source image 31 the user is currently specifying.

The algorithm for calculating the extent of the subset is discussed below.

4. Releasing the mouse button

The handle 33 and all other decoration on the frame may reappear if they were hidden in step 2.

In step 3 above, the subset of the source image is calculated by determining the distance from the current pointer position to the position at the time of the button press in step 2. Note that the region may be rotated by the user prior to the use of the crop-to-fill mode; in this case the interpretation of the pointer position must take this rotation into account.

A sample implementation of this technique is as follows:

```
When the mouse moves in crop-to-fill mode on a region object ppi,
{
  REAL xAnchor = −1;
  REAL yAnchor = −1;
  // store the rect of both the containing region and the source region
  RectF rcImage(ppi->GetImageBox( ));
  RectF rcFrame(ppi->GetFrameBox( ));
  // compute an anchor position for the resizing of the source region
  if (a top handle is being dragged)
  {
    yAnchor = rcImage.Height − (rcImage.GetBottom( ) −
    rcFrame.Height);
  }
  else if (a bottom handle is being dragged)
  {
    yAnchor = −rcImage.Y;
  }
  if (a left handle is being dragged)
  {
    xAnchor = rcImage.Width − (rcImage.GetRight( ) − rcFrame.Width);
  }
  else if (a right handle is being dragged)
  {
    xAnchor = −rcImage.X;
  }
  ppi->ExplodeImageBy(
        −in_xMove, −in_yMove,
        xAnchor, yAnchor,
        dwFlags | EB_AdjustForRotation | ((m_fMaintainAspect) ?
        EB_KeepRatio : 0));
}
void CRegion::ExplodeImageBy(
            REAL in_cx, REAL in_cy,
            REAL in_xCenter, REAL in_yCenter,
            DWORD n_dwFlags )
{
  if (in_dwFlags indicate that rotation needs to be accounted for)
  {
    rotate in_cx and in_cy by the inverse of the frame's current rotation
  }
  RectF rcImage = ExplodeBox(m_rcImage,
                    in_cx, in_cy,
                    in_xCenter, in_yCenter,
                    in_dwFlags & ˜EB_KeepRatio);
  if (in_dwFlags indicate that a top handle was being dragged)
  {
    rcImage.Height = rcImage.Width / m_szOrigPage.Width *
    m_szOrigPage.Height;
  }
  else if (in_dwFlags indicate that a bottom handle was being dragged)
  {
    REAL fCY = rcImage.Height;
    rcImage.Height = rcImage.Width / m_szOrigPage.Width *
    m_szOrigPage.Height;
    rcImage.Y −= (rcImage.Height − fCY);
  }
  SetImageBox(rcImage);
}
```

Crop-To-Fill Mode

Once the mouse button was pressed while the cursor 40 was over the crop handle 33 in step 2 of the previous section, and until the mouse button was released in the subsequent step 4, the graphics system was in “crop-to-fill mode”.

In another embodiment of this invention, the user has other means for entering and leaving this mode for a given selected region(s), such as via the use of a keyboard:

1. Pressing and releasing a key (such as ‘c’) to enter crop-to-fill mode (applying the cropping using any technique described here)

2. Subsequently pressing a key (such as ‘enter’, or ‘c’ again) to accept the crop and exit the mode or

1. Pressing and holding a key (such as ‘c’) to enter frame segmentation mode (applying the segmentation using any technique described here)

2. Subsequently releasing said key to accept the crop and exit the mode

Aborting Cropping

In another embodiment of this invention, the user is able to abort the cropping operation while in Crop-To-Fill Mode. This is accomplished by pressing a key, such as the ‘esc’ key. This removes any previewed cropping, refreshes the display to include the handles decorating the regions again if necessary, and exits Crop-To-Fill Mode.

Modifications and Alternate Embodiments

Having described the invention, it should be apparent to those of ordinary skill in the art that the foregoing is illustrative and not limiting. Numerous modifications, variations and alterations may be made to the described embodiments without departing from the scope of the invention by one of ordinary skill in the art and are contemplated as falling within the scope of the invention as defined by the appended claims.

1. A method, operatable on a computer system, for specifying a source extent of a source image to fill an enclosing region on a display using an input device, the image composed of a two-dimensional graphical object, the region composed of a bounding area, the display including a representation of one or more regions within a larger area or volume, the input device capable of converting user input into a two or three-dimensional position, the method comprising:
entering an interactive crop-to-fill mode
interactively specifying an update to said source extent of said source image visible within said enclosing region using said input device without affecting exterior dimensions of said enclosing region
leaving said interactive crop-to-fill mode

2. The method of claim 1 wherein the display further associates a visual control with each corner of each region which enables interactive crop-to-fill mode, said controls to be rendered visible either upon selection of the region, upon entry into the region by a pointing device, or at all times.

3. The method of claim 1 wherein the step of entering and subsequently leaving the interactive crop-to-fill mode comprises pressing a button on a computer mouse over a visual control associated with one of the selected regions and subsequently releasing the button.

4. The method of claim 1 wherein the step of entering and subsequently leaving the interactive segmenting mode comprises pressing a key on the keyboard and subsequently releasing it.

5. The method of claim 1 wherein the specification of the source image extent is computed by
determining which corner of said source extent of said source image is being manipulated;
determining the current position of a pointing device in a coordinate system determined by the original location and size of said source extent prior to interaction
updating the extent of said source extent and therefore the subregion of said source image to be drawn within said containing region such that the corner of said source image is set to said current pointer position in said source image coordinate system.

6. The method of claim 1 wherein the cropping is applied to said source image when the crop-to-fill mode is exited, and the user is further able to abort cropping, the method for aborting comprising
Pressing a key, such as the ‘escape’ key

7. A computer readable medium having computer instructions stored thereon for implementing a method of specifying a source extent of a source image to fill an enclosing region on a display using an input device, the image composed of a two-dimensional graphical object, the region composed of a bounding area, the display including a representation of one or more regions within a larger area or volume, the input device capable of converting user input into a two or three-dimensional position, the method comprising:
entering an interactive crop-to-fill mode
interactively specifying an update to said source extent of said source image visible within said enclosing region using said input device without affecting exterior dimensions of said enclosing region
leaving said interactive crop-to-fill mode

8. The computer readable medium of claim 7 wherein the display further associates a visual control with each corner of each region which enables interactive crop-to-fill mode, said controls to be rendered visible either upon selection of the region, upon entry into the region by a pointing device, or at all times.

9. The computer readable medium of claim 7 wherein the step of entering and leaving the interactive crop-to-fill mode comprises pressing a button on a computer mouse over a visual control associated with one of the selected regions and subsequently releasing the button.

10. The computer readable medium of claim 7 wherein the step of entering and leaving the interactive segmenting mode comprises pressing a key on the keyboard and subsequently releasing it.

11. The computer readable medium of claim 7 wherein the specification of the source image extent is computed by
determining which corner of the region said source image is being manipulated;
determining the current position of the mouse pointer in a coordinate system determined by the original location and size of the source image prior to interaction
updating the extent of said image drawn within said containing region such that the corner of said image is set to said current pointer position in said source image coordinate system.

12. The computer readable medium of claim 7 wherein the cropping is applied to the contained image when the crop-to-fill mode is exited, and the user is further able to abort cropping, the method for aborting comprising
Pressing a key, such as the ‘escape’ key
